(19) United States
(12) Patent Application Publication
(10) Pub. No.: US 2018/0206501 A1
(43) Pub. Date: Jul. 26, 2018

(54) CONTROLLING DISEASES AND INSECTS IN PLANTS

(71) Applicants: John D. Blizzard, Bay City, MI (US); Robert L. McKellar, Midland, MI (US); Joan McMahon, Midland, MI (US)

(72) Inventors: John D. Blizzard, Bay City, MI (US); Robert L. McKellar, Midland, MI (US); Joan McMahon, Midland, MI (US)

(21) Appl. No.: 15/874,315

(22) Filed: Jan. 18, 2018

Related U.S. Application Data
(60) Provisional application No. 62/449,274, filed on Jan. 23, 2017.

(51) Int. Cl. A01N 57/34; A01N 55/00

(52) U.S. Cl. CPC A01N 57/34; A01N 55/00

(57) ABSTRACT

A method for controlling diseases and insects in plants on one hand and a method for providing a plant growth regulator on the other hand.

### BACKGROUND OF THE INVENTION

The invention consists of the discovery of a method for controlling diseases and insects in plants on one hand and a method for providing a plant growth regulator on the other hand.

In general there are two ways to stop microbes from infecting or deteriorating antimicrobial surfaces. The first is usually realized by disinfectants, which are a considerable environmental pollution problem and also support the development of resistant microbial strains. Antimicrobial and/or antifungal surfaces are usually designed by impregnation of materials with biocides that are released into the surroundings whereupon microbes are killed.

Cercospora leafspot, for example, overwinters in the soil on decomposing soy bean leaves from previous uninfected soy bean crops and on weed residues. When conditions are favorable, that is, high temperatures and humidity, spores are produced and are blown onto or splashed on soy bean leaves, where the spores germinate and infect the leaves. The disease grows inside the leaf and begins breaking down cell tissue, creating necrotic spots. The soy beans natural defenses “wall off” the damaged tissue and limit the size of spots to about ⅛ inch in diameter

The supply of effective fungicides now used commercially is limited. Triazoles are absorbed by plants and are rain-fast when dried on the leaf. Triazoles move within the leaf and protect the upper and lower surfaces, however, they do not move from leaf to leaf. Protectant fungicides (Super Tin, EBDC's and Coppers) are not absorbed by the leaves and are susceptible to being washed off by rainfall. Spray coverage is more important for protectants because they are not systemic. Because of these short comings of currently available fungistats, Cercospora leaf spot continues to be a serious impediment to soy bean production.

Thus, there is a desperate need for controlling microbes, fungi, mold, yeast, mildew, and insects in agricultural crops. For example, molds, fungi, and mildews claim millions of dollars of loss in sugar beets and other agricultural crops. Methods that are used now include spraying of the crops with mildewicides and the like. This method is extremely unattractive to farmers because of the fact that the fields have to be sprayed several times and the mildewicides are expensive. Another downside is the fact that such materials are ingested and thus create an immunity in the attacking species over time. A third reason is that such materials are not ecologically safe and thus farm fields carry a heavy burden of sprayed chemical materials.

There is also a need to control insect pests, and the compositions of this invention can control such pests as red spider mites, aphids, and the like.

It has also been discovered that some of the compositions of the instant invention are plant growth regulators

One of the materials of this invention, (CH₃O)Si(CH₂)N⁺(CH₃)₂ (C₁₈H₃₇)Cl⁻, has been used in prior art applications after being modified. Thus, there is disclosed in U.S. Pat. No. 5,954,869, issued Sep. 21, 1999, a water-stabilized organosilane compound and methods for using the same, which methods include among others, a method of dyeing and treating a substrate, a method of antimicrobially treating a food article, a method of antimicrobially coating a fluid container, a method of antimicrobially coating a latex medical article, and a method of making a siloxane in the presence of a stabilizer. The composition is formed by mixing an organosilane, with a polyol containing at least two hydroxy groups, wherein at least any two of the hydroxy groups are separated by not more than two intervening atoms.

In U.S. Pat. No. 6,113,815, issued on Sep. 5, 2000, there is disclosed a composition formed by mixing an organosilane with an ether. The composition is used for dyeing and treating a substrate, for antimicrobially treating a food article, a method for antimicrobially coating a fluid container and a method for antimicrobially coating a latex medical article.

In U.S. Pat. No. 6,120,587, issued on Sep. 19, 2000, there is disclosed a composition formed by mixing an organosilane with a polyol. The patent is a divisional of U.S. Pat. No. 5,954,869.

U.S. Pat. No. 6,469,120 deals with a composition found in the '869 patent in that the patent is a continuation of the '869 patent.

U.S. Pat. No. 6,762,172 that issued Jul. 13, 2004 deals with the organosilane mixed with an organic carbonate. It is used in essentially the same end use methods as found in the foregoing patents.

It would be very beneficial if there was a method of treating agriculture fields with a material that would not be expensive, would not require many applications to the crop, would not create immunity in the attacking species and would be essentially ecologically friendly.

### THE INVENTION

Thus, there is disclosed and claimed herein a method of controlling diseases in plants. The method comprises providing at least one plant and contacting the plant with an aqueous solution of a material selected from the group consisting of a sulfonium salt of the formula (R)₃SiC_{d}H_{2d}S⁺(R⁴)₂X⁻ in which R⁴ is independently an alkyl group or aralkyl group wherein there is a total of less than 60 carbon atoms in the molecule, d is an integer of 1 or greater and X⁻ is a water soluble monovalent anion;

an isothiuronium salt of the formula (R)₃SiC_{d}H_{2d} S⁺C(NH₂)₂X⁻, d is an integer of 1 or greater and X⁻ is a water soluble monovalent anion; a phosphonium salt of the formula (R)₃SiC_{d}H_{2d}P⁺(R⁶)₃X⁻ in which R⁶ is independently selected from an alkyl group or aralkyl group wherein there is a total of less than 60 carbon atoms in the molecule, d is an integer of 1 or greater and X⁻ is a water soluble monovalent anion;

a quaternary ammonium salt of the formula (R)₃SiC_{d}H_{2d}N⁺(CH₃)₂ (CₑH₂ₑ)X⁻ in which d is an integer of 1 or greater, e has a value of from 12 to 20, and X is a water soluble monovalent anion, and,

an amine of the formula (R)₃SiC_{d}H_{2d}N(H)(C_{d}H_{2d}) NH₂ wherein d is an integer of 1 or greater, wherein in each formulae, R is selected from the group consisting of —OCH₃, —OCH₂CH₃, —OCH(CH₃)₂, O(CH₂)₃CH₃, —OCH₂CH(CH₃)₂, —O(2-ethylhexyl), acetoxy, and, oximo. Thereafter, at a pre-determined time from the contact set forth Supra, contacting the plant with the aqueous solution a second time.

Examples of useful materials in this invention include (CH₃O)₃Si(CH₂)P(O)(CH₃)(OCH₃)₂; (CH₃O)₃SiC₂H_{2d}P⁺(R)₃Cl⁻; (CH₃O)₃SiC₂H_{2d}S⁺(R)₂X⁻; (CH₃O)₃SiC₂H_{2d}S⁺C⁻ (NH₂)₂X⁻, and (CH₃O)₃Si(R)₂C_{d}H_{2d} N(H)(C_{d}H_{2d})NH₂, wherein d has a value of at least 1.

Specifically, preferred materials are (CH₃O)Si(CH₂)N⁺(CH₃)₂(C₁₈H₃₋₇) Cl⁻, N-(trimethoxysilylpropyl)isothiuronium chloride and 2-(4-chlorosulfonylphenyl)ethyltrimethoxysilane.

### DETAILED DESCRIPTION OF THE INVENTION

Because control with Fungicides, both systemic and contact fungicide options, have not been totally effective to control Cercospora leafspot in soy beans, an evaluation was carried out to test the effectiveness of a covalently bound antimicrobial/anti-fungal organosilane against Cercospora leafspot fungus.

While the application of this bound antimicrobial/antifungal material is well known for effective use on fabrics, coating, protectants, and many other uses, its use on plants to control disease and insects has not been promoted in industry. Initial studies by the inventors herein on diseases and insects have demonstrated these compounds to be very effective.

It should be recognized that the field evaluation in this study was performed with a very limited knowledge base of how to apply in the field, the concentration of the antifungal necessary for efficiency and control, the required reapplication schedule and how to fully evaluate the effectiveness of the antifungal spray.

The studies on fungus have demonstrated these compounds to be very effective. These compounds will potentially control Cercospora leafspot fungus at extremely low (<100 ppm) application concentrations. Additionally, these silanes can potentially be incorporated into both current systemic, and contact fungicides, offering an unprecedented dual system for control of Cercospora leafspot fungus. Additionally, since these compounds covalently bond to the leaf strata, they do not promote fungal resistance, as the mode of disruption is rupture of the fungus spores and not systemic. Also since these compounds covalently bond to the leaf surface, they are not washed off during wet or rainy seasons.

Continued application of these materials to agricultural fields, year after year, builds into the soil an effective barrier to fungus, mildew, microbes, mold, yeast, and insects in agricultural crops, as the material is covalently bonded to the leaves and the plant stems, which go back into the soil during harvest. The leaves and plant stems thus carry with them the materials of this invention which act as anti-fungus, anti-mildew, antimicrobial, anti-mold, and anti-yeast barriers in the soil.

It has been noted that the materials of this invention are more effective than known materials for treating agricultural crops, as the materials of the instant invention do not have to be sprayed more than about 2 to 3 time versus the current technology of spraying 5 to 7 times per year.

Cercospora kikuchii causes leaf blight and purple seed stain on soybean plants. Approximately a ten acre field of soy beans was used for testing. The same format was used for the testing on soy beans as was utilized for the field applied antifungal sugar beet tests.

### EXAMPLES

### Example 1

A sugar beet farmer was asked to set aside a planted sugar beet portion of his sugar operation for field testing. The area was approximately 4200 square feet in area. This was divided off into sections (rows) of sugar beets that were approximately 10 to 14 inches tall. This area of beet production was only sprayed with a weed killer and no antifungal sprays. The map of this area is shown in the plot map below.

Once the area had been sectioned off, samples of soil and leafs were taken. The soil samples were prefixed with an “S” while the leaf specimens were labeled with a prefix of “L”. The approximate area of sampling is denoted on the plot map with either an “S-” or an “L” followed by the sample number. Map coordinates are designated using an X/Y coordinate mapping of A-G/1-6. In all, a total of 30 rows of sugar beets were incorporated into this evaluation.

### Sugar Beet Plot Map

| Jun. 27, | | | | | | | | | | |
|---|---|---|---|---|---|---|---|---|---|---|
| 2016 | 1 | 2 | 3 | | 4 | | 5 | | 6 | Rows |
| A | | | S-3 | L-13 | | L-10 | L-20 | S-4 | | 5 |

| | | | | | | | | |
|---|---|---|---|---|---|---|---|---|
| B | x | S-7 | L-3 | L-14 | | L-21 | L-6 | 4 |
| C | x | | L-5 | L-15 | | L-22 | | 4 |
| D | L-1 | S-2 | L-2 | L-16 | S-5 | L-23 | L-11 | 4 |
| E | x | L-7 | L-8 | L-17 | | L-24 | L-9 | 4 |

| | | | | |
|---|---|---|---|---|
| F | x | L-18 | L-25 | 4 |

| | | | | | | |
|---|---|---|---|---|---|---|
| G | x | S-1 | L-12 | L19 | S-6 | 5 |
| | | | | | L26 | |

| | | | |
|---|---|---|---|
| | height | width | sq. ft. |
| A--1 | 37 | 24 | 888 |
| to D-2 | | | |
| A-3 | 57 | 58 | 3306 |
| to G-6 | | | |
| Total | | | 4194 |

### Formulations

Three formulations were made for field evaluations. The only component that changed was the concentration of the antifungal ingredient of this invention. Additionally, sample 3 was made at a higher antifungal concentration that was diluted to 0.5% final spray application. Two concentrations of the inventive formulation were as made for the first spray application. This is summarized in Table 1.

| | | 5 gallon | | 5 gallon | | 5 gallon |
|---|---|---|---|---|---|---|
| | | form | | form | | form |
| | Formula: | Formula: | Formula: | Formula: | Formula: | Formula: |
| | 1 | 1 | 2 | 2 | 3 | 3 |
| water | 99.83 | 39.93 | 99.49 | 39.8 | 95 | 38 |
| ztrex 72* | 0.16 | 0.06 | 0.5 | 0.2 | 5 | 2 |
| | | (29 g) | | (90.8 g) | | |
| 5211\hat{ } | 0.01 | 0.04 | 0.01 | 0.04 | 0.01 | 0.04 |
| | | (18 g) | | (18 g) | | (18 g) |

*Ztrex72 is (CH₃O) Si (CH₂)N⁺ (CH₃)₂ (C₁₈H₃₇) Cl⁻
\hat{ }5211 is a siloxane/glycol surfactant obtainable from the Dow Corning Corporation, Midland, Michigan.

### Spray Application

Spray application was performed with a two gallon pump sprayer. This was done by following each of the sugar beet rows and spraying the solution directly onto the beet green.

Ten gallons of formulation 1 and 2 were made and this required that the entire 10 gallons had to be hand sprayed to the designated area shown on the plot map. An initial spray application was done. Rows B-3 through rows C-6 were spray applied with formulation 1. Rows E-3 through rows F-6 were sprayed with formulation 2. Rows G-3 through G-6, and A-1 through D-2 were all designated as control areas with no spraying on those sections. Samples were taken 48 hours after spraying. After thirty days a second set of leaf samples were taken.

After samples were taken the second spray application of Formulation 3 (diluted to 0.5% actives) was done on Rows C-3 through C-6, and F-1 through F-2. After fifteen days a further set of leaf samples were taken from the entire test area along with a sample of the green from the commercially sprayed sugar beet field (Sample 30).

### Leaf Sampling

Leaf cutting was done periodically to evaluate the performance of the antifungal coating. After cutting, each leaf cutting was placed into an individually labeled gallon storage bag and then tested. Each cutting was 2 to 3 leaves from the designated plant area. A compilation of data is shown in Table 2. This includes the date samples were taken, the formulation that was used, the number of spray applications and any comments.

TABLE 2
L-1 to L-3 are leaf controls
S-1 to S-6 are soil controls

| | formulation | sprays | Bacteria |
|---|---|---|---|
| Jul. 13, 2016 | | | |
| L-4 | 1 | 1 | |
| L-5 | 1 | 1 | |
| L-6 | 1 | 1 | |
| L-7 | 2 | 1 | |
| L-8 | 2 | 1 | |
| L-9 | 2 | 1 | |
| L-10 | | | |
| CONTROL | | | |
| L-11 | | | |
| CONTROL | | | |
| L-12 | | | |
| CONTROL | | | |
| Aug. 15, 2016 | | | |
| L-13 | | | TNTC |
| CONTROL | | | |
| L-14 | 1 | 1 | TNTC |
| L-15 | 3 | 2 | very small 3 |
| | | | colonies |
| L-16 | | | some heavy |
| CONTROL | | | |
| L-17 | 2 | 1 | no colonies |
| L-18 | 3 | 2 | 1 large |
| | | | colony |
| L-19 | | | TNTC |
| CONTROL | | | |
| Soil sample | | | TNTC |
| Aug. 30, 2016 | | | |
| L-20 | | | TNTC |
| CONTROL | | | |
| L-21 | 1 | 1 | POOR |
| L-22 | 1 | 2 | POOR |
| L-23 | | | |
| CONTROL | | | |
| L-24 | 2 | 1 | GOOD |
| L-25 | 2 | 2 | BEST |
| CONTROL | | | TNTC |
| L-30 | BEET FIELD | | BEST |

### Soil Testing

Samples of the soil in the test plot area was taken and labeled with an “S” designation. Approximately 400 grams of soil was removed from each area, was placed into an individually labeled gallon storage bag and tested. Additionally the soil and air temperatures were measured. Testing included soil pH, nitrate level and soil moisture content. This is compiled in Table 3.

TABLE 3
Soil Testing

| | | v. l. | |
|---|---|---|---|
| | | mist | |
| air T; | 56 | rain | |
| soil T; C | 22 | | |
| | | | % Soil |
| | pH | NO3− | Moisture |
| S-1 | 6.49 | 21.3 | 3.45 |
| S-2 | 6.43 | 6.9 | 3.77 |
| S-3 | 6.51 | 8.4 | 2.68 |
| S-4 | 6.49 | 19 | 4.4 |
| S-5 | 6.49 | 11.8 | 2.67 |
| S-6 | 6.34 | 10.6 | 2.42 |
| Total | 38.75 | 78 | 19.39 |
| Average | 6.45 | 13 | 3.23 |

### Additional Leaf Testing

The initial leaf cuttings from L-1 to L-3 were used for additional evaluations. These leaves did not have any antifungal spray applied to them. All of the leaves were very green, showing no signs of Cercospora. When the leaves were cultured and incubated (three plates per sample), the plate counts on all of the samples were too numerous to count (TNTC) indicating signs of Cercospora infection.

The control sample was taken from a known infected control sample. In addition to the normal culturing process, leaf samples from L-1 and the Control were treated in the laboratory. This involved placing the leaf culture onto the agar incubation plate, over spraying the plate with a 0.5% solution Ztrex 72 and 5211 surfactant in water. The plates were further incubated for 24 hours. After incubation there was no evidence of Cercospora on the incubation plate as shown in Table 4.

TABLE 4

| | Cer. Count/3 | 0.5% 5772 |
|---|---|---|
| | plates | spray |
| L-1 | TNTC | none on the |
| | | leaf |
| L-2 | TNTC | |
| L-3 | TNTC | |
| Control | TNTC | none on the |
| | | leaf |

Our Control sample was obtained from Michigan Sugar Company, Bay City, Mich. and was used for all of the initial lab studies. This sample was a dried leaf sample which had a large dried population of Cercospora.

### Example 2

For application in the soy bean field, only one formulation at one concentration was utilized for this initial study. For this formulation, Formulation 4, seven 5 gallon pails of a 5% concentrate were made. These formulations are set forth in Table 5.

TABLE 5

| | | 7:5 | | |
|---|---|---|---|---|
| | Formulation: 4 | gallon | | Final |
| Water | 95 | 38 | Water | 99 |
| Ztrex | | | Ztrex | |
| 72 | 5 | 2 | 72 | 1 |
| 5211 | 1 | 73 g | 5211 | 0.2 |

### Soy Bean Spray Application

The Formulation 4 was placed into a 150 commercial spray tank and diluted with water to achieve a final actives spray concentration of one percent. This 150 gallon dilution was used to spray ten acres of growing soy beans.

### Soy Bean Leaf Sampling

Leaf cutting was done periodically to evaluate the performance of the antifungal coating. After cutting, each leaf cutting was placed into an individually labeled gallon storage bag. Each cutting was 2 to 3 leaves from a designated plant area. A compilation of data is shown in Table 6.

TABLE 6

Jul. 20, 2016
L-1
CONTROL
L-2
CONTROL
Aug. 12, 2016
L-3
L-4
CONTROL

| Aug. 23, 2016 | Bacteria |
|---|---|
| L-5 | some |
| L-6 | heavy |
| CONTROL | TNTC |
| L-5 2 | very |
| spray | little |

### Soy Bean Soil Testing

Samples of the soil in the test plot area was taken and labeled with an “S” designation. Approximately 400 grams of soil was removed from each area, was placed into an individually labeled gallon storage bag. Testing included soil pH and nitrate level.

Soil Test
results

| | |
|---|---|
| Ph | 8.02 |
| NO3− | 6.9 |

It was noted by the farmer that the soybean plants were noticeably larger than the plants that were not treated in this manner, however, the yield of beans from the plants was near normal.

How fast and large the leaf grows was not addressed. This is a critical parameter as the antifungal is bound to the leaf surface. As the leaf grows, new untreated leaf is exposed to Cercospora which if left untreated will grow and kill the untreated leaf area, thus, At least more than one spray application will be necessary to be sufficiently effective against Cercospora. Reapplication of the antifungal spray in the laboratory on infected leaves, did eliminate the Cercospora on the leaves.

### Example 3

A Colorado Blue spruce tree of about 6 foot in height was noted as having a problem with red spider mites in that a large portion of the lower part of the tree (about ¼) appeared to be dead and without needles. The entire tree was sprayed with 0.5% aqueous solution as was used in Example 1 for sugar beets. After about three weeks, the dead portion of the tree was noted to grow new needles and almost the entire area previously affected was restored after about five weeks. Eventually, the devastated portion of the tree caught up to the remainder of the tree in terms of needle growth.

### Example 4

An eight foot pear tree having five varieties of pears was treated in early march with the 0.5% of aqueous solution as used in example 1 on sugar beets. The tree was treated a second time in early May just at budding but before a flower had formed. The tree was never treated thereafter with the inventive formula or any kind of insecticidal spray. A full harvest was taken in August of the pear crop and it was noted that only one pear had an irregularity in its surface and that only two pears had dropped early.

### Example 5

When Cannabis plants were treated with an 0.16% aqueous solution of the material as used in Example 1 for sugar beets, it was noted that red spider mites were readily controlled. It was further noted from a greenhouse study that red spider mite eggs were also killed by the use of such a material for complete control of red spider mites in Cannabis.

### Example 6, 7 and 8

### Example 6

A mixture of 20 grams (CH3O)2SiCH2CH2CH2Cl (SIC 2410) and 2.5 grams CH3PO(OCH3)2 (D169102) with 0.1 grams benzyl dimethylamine catalyst (185582) was warmed to 182° C. during one hour with mixing. Sample P-1 #14. 13.4 grams of a crude clear viscous product was obtained.

| | | | P-1 |
|---|---|---|---|
| | Mw | moles | #14 |
| SIC 2410 (ClPr) | 198.7 | 2 | 20 |
| D169102 (Me2) | 124.1 | 2 | 12.5 |
| 185582 (NH2) | 135.2 | 0.015 | 0.1 |
| heat, C | 182/ | | clear |
| time, min | 60 | | viscous |
| | | | liquid |
| Distill, recover | | | 13.4 |

| | |
|---|---|
| Application, microbial kill | 99.99 |

| Sample # | Mw | 7 |
|---|---|---|
| 8405 @ 50% in water | 274.8 | 5.5 |
| | | (2.75) |
| water pH = 10 | 18 | 1 |
| Solution @ 24 hours | | clear |
| Application, microbial | | 99.99 |
| kill | | |
| Sample # | | 8 |
| 2417 @ 50% in MeCl | 324.85 | 6.5 |
| | | (3.25) |
| water pH = 10 | 18 | 1 |
| Solution @ 24 hours | | Clear |
| Application, microbial | | 99.99 |
| kill | | |

| | |
|---|---|
| 8405 | N-(trimethoxysilylpropyl) |
| | isothiuronium chloride |
| 2417 | 2-(4-chlorosulfonylphenyl) |
| | ethyltrimethoxysilane |

### Microbial Testing

### Purpose:

The purpose of this study was to evaluate the effectiveness of test materials labeled #6, #7 and #8, in killing or reducing Escherichia coli (E. coli). The standard pour plate count test method was used to evaluate Percent Reduction of Colony Forming Units (CFU).

### Study Design

The E. coli (lot number 168756) was purchased from Quanti-Cult™ and is derived from original ATCC® stock cultures. They are received dehydrated. A viable streak plate was colonized from this culture. One colony was transferred to 5 ml of sterile Tryptic Soy Broth (lot # A3303) and incubated overnight. Antimicrobial activity was determined by comparing results from the test sample to simultaneously run controls or from the T₀. The concentration of the suspension was determined using serial dilution and plate counts to determine the amount of Colony Forming Units (CFU's)/ml of suspension.

The materials tested in this study are described in the Purpose section. Sterile 0.3 mM KH₂PO₄ buffer was inoculated to a concentration of ˜1.0-3.0×10⁵ CFU/ml. A To plate originated from the inoculated buffer for quantification and prepared 1:100 dilution to insure that viable inoculum was applied in the test system. The test materials were formulated in 20×150 ml test tubes. Aliquots of 0.3 grams of each of the materials (#6, #7 and #8) were added to sterile test tubes. Five ml of Tryptic Soy Broth was added to each tube and the tubes inoculated with 1×10⁵ CFU, E. coli. The materials were incubated for 48 hours. T₀ of the inoculums was 9.6×10⁴ CFU/ml. One milliliter aliquots of the test article inoculums were added to Petri dishes, Plate Count Agar added and swirled and the plates were incubated at 35° C. overnight.

Results

The results show 16 CFU/ml for material #6, #7 and #8 or >99.9% reduction or 100% reduction.

Plants that can be treated by this invention include, but are not limited to, fruit trees, conifer trees, soybean plants, sugar beet plants, white bean plants, cannabis, corn plants, flowering plants, hop plants, ornamental plants, wheat, banana plants, and rye.

What is claimed is:

1. A method of controlling diseases in plants, said method comprising:
A. providing at least one plant;
B. contacting said plant with an aqueous solution of a material selected from the group consisting of:
i. a sulfonium salt of the formula
(R)₃SiC_{d}H_{2d}S⁺(R⁴)₃X⁻
in which R⁴ is independently an alkyl group or aralkyl group wherein there is a total of less than 60 carbon atoms in the molecule, d is an integer of 1 or greater and X⁻ is a water soluble monovalent anion;
ii. an isothiuronium salt of the formula
(R)₃SiC_{d}H_{2d}S⁺C(NH₂)₂X⁻,
d is an integer of 1 or greater and X⁻ is a water soluble monovalent anion;
iii. a phosphonium salt of the formula
(R)₃SiC_{d}H_{2d}P⁺(R⁶)₃X⁻
in which R⁶ is independently selected from an alkyl group or aralkyl group wherein there is a total of less than 60 carbon atoms in the molecule, d is an integer of 1 or greater and X⁻ is a water soluble monovalent anion;
iv. a quaternary ammonium salt of the formula
(R)₃SiC_{d}H_{2d}N⁺(CH₃)₂(CₑH₂ₑ)X⁻
in which d is an integer of 1 or greater, e has a value of from 12 to 20, and X is a water soluble monovalent anion, and,
v. an amine of the formula
(R)₃SiC_{d}H_{2d}N(H)(C_{d}H_{2d})NH₂
wherein d is an integer of 1 or greater, wherein in each formulae, R is selected from the group consisting of:
a. —OCH₃,
b. —OCH₂CH₃,
c. —OCH(CH₃)₂,
d. —O(CH₂)₃CH₃,
e. —OCH₂CH(CH₃)₂,
f. —O(2-ethylhexyl),
g. acetoxy, and,
h. oximo;
C. after a pre-determined time from the contact in B., contacting said plant with said aqueous solution a second time.

2. The method as claimed in claim 1 wherein the plant is a fruit tree.

3. The method as claimed in claim 1 wherein the plant is a conifer tree.

4. The method as claimed in claim 1 wherein the plant is a soybean plant.

5. The method as claimed in claim 1 wherein the plant is a sugar beet plant.

6. The method as claimed in claim 1 wherein the plant is a white bean plant.

7. The method as claimed in claim 1 wherein the plant is Cannabis.

8. The method as claimed in claim 1 wherein the plant is corn.

9. The method as claimed in claim 1 wherein the plant is a flowering plant.

10. The method as claimed in claim 1 wherein the plant is a hop plant.

11. The method as claimed in claim 1 wherein the plant is an ornamental plant.

12. The method as claimed in claim 1 wherein the plant is wheat.

13. The method as claimed in claim 1 wherein the plant is a banana plant.

14. The method as claimed in claim 1 wherein the plant is rye.
